(19) United States
(12) Patent Application Publication
(10) Pub. No.: US 2007/0143003 A1
(43) Pub. Date: Jun. 21, 2007

(54) Single-handed operating navigation apparatus

(75) Inventor: Stephen Chien, Shengang Shiang (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 11/304,740

(22) Filed: Dec. 16, 2005

(51) Int. Cl. G01C 21/00

(52) U.S. Cl. 701/200; 701/213

(57) ABSTRACT

A single-handed operating navigation apparatus allows aims to provide rapid scanning and confirmation of selection items single-handed. It mainly includes a base, a screen, a rotary disk and at least one pushbutton. The base contains a navigation host and a GPS satellite receiver. The screen aims to display navigation information. The rotary disk can rotate continuously clockwise or counterclockwise to provide fast scanning and operation of the selection items. The pushbutton includes at least one selection item confirmation button and one selection item activation button. The navigation apparatus thus formed enables users to rapidly do navigation setting single-handed.

### BACKGROUND OF THE INVENTION

1. Field of the Invention

The invention relates to a single-handed operating navigation apparatus and particularly to a navigation apparatus that is operable single-handed to facilitate fast scanning and confirming of selection items to set navigation rapidly.

2. Description of the Prior Art

On the conventional navigation apparatus, operation of entering a destination generally is the most complicated task. Although there are many methods available for entering input, such as hand-writing recognition, joy stick selection or directional key and the like, they still have problems when in use, notably:
1. Hand-writing method: While it provides direct input and is convenient, every person has a different hand writing habit. It could become a challenge to users. It often happens that some users can speak but cannot spell words correctly. In such a condition, hand-writing becomes useless.
2. Joy stick selection or direction key: This approach adopts multi-directional movements to allow users to make selection. For instance, R.O.C. patent No. 182456 discloses a technique which can move a selection item on a menu for one line by pushing a joy stick (or directional key) once. While it overcomes the inconvenience of the hand-writing method, the navigation apparatus contains and displays many road and location names. The selection of moving one line by pushing once is too slow and takes too much time. It is not convenient.

### SUMMARY OF THE INVENTION

In view of the aforesaid disadvantages, the object of the invention is to provide a navigation apparatus that can be operated single-handed to rapidly scan selection items and confirm selections. It mainly includes a base, a screen, a rotary disk and one or more pushbuttons. The base contains a navigation host and a GPS satellite receiver. The screen aims to display navigation information. The rotary disk can be rotated continuously clockwise or counterclockwise to allow users to rapidly scan and make selection. The pushbuttons include at least one selection item confirmation button and one selection item activation button. By means of such a construction, users can quickly operate and set navigation single-handed.

In one aspect, the rotary disk is a circular wheel that can be rotated continuously clockwise or counterclockwise.

In another aspect, the rotary disk is a capacitance touch sensitive plate which has one or two dimensional coordinates with a head and a tail connecting to each other.

In yet another aspect, the rotary disk is a mechanical rotary wheel.

In still another aspect, the rotary disk is divided into a plurality of small segments corresponding to selection items of the menu. The rotary disk can be rotated for a selected angular position to correspond to the number of segments being moved. Each segment is set to correspond to one selection item on the menu. Hence the angular displacement is corresponding to the number of segments being moved to allow rapid movement of the selection items. For instance, by setting one rotation into 50 segments, and one segment corresponding to one selection item, rotating the rotary disk one time can move 50 selection items on the menu. Thus it is a more effective tool to search a greater amount of data or input characters.

In another aspect, the rotary disk of the invention has four polar buttons for up, low, left and right directions to function as the directional buttons to move upwards, downwards, leftwards and rightwards.

In another aspect, the pushbuttons of the invention have at least one button located beneath the rotary disk to function as the selection item confirmation button or selection item activation button that is operable without moving user's palm.

In another aspect, the screen of the invention has upward and downward switch functions. The rotary disk can be located on the left side or right side of the screen to enable users to operate left-handed or right-handed.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a first embodiment of the invention.

FIG. 2 is an operation flow chart of the invention.

FIG. 3 is another schematic view of the first embodiment of the invention.

FIG. 4 is another operation flow chart of the invention.

FIG. 5 is an exploded view of the rotary disk of a second embodiment of the invention.

FIG. 6 is a schematic view of the second embodiment of the invention.

FIG. 7 is a schematic view of a third embodiment of the invention.

FIG. 8 is a schematic view of an embodiment of the invention used in a vehicle.

FIG. 9 is an operation block diagram of the invention.

### DESCRIPTION OF THE PREFERRED EMBODIMENTS

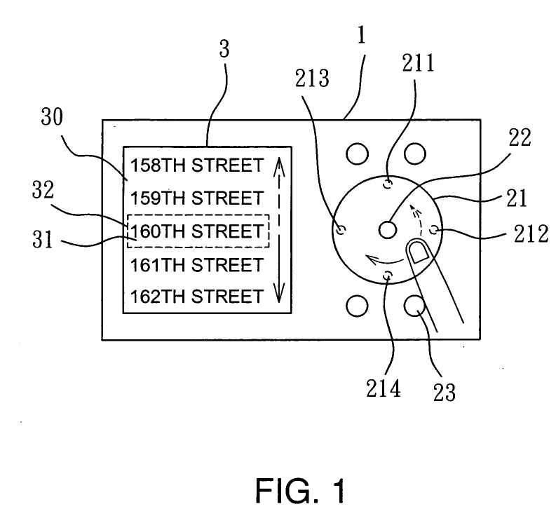

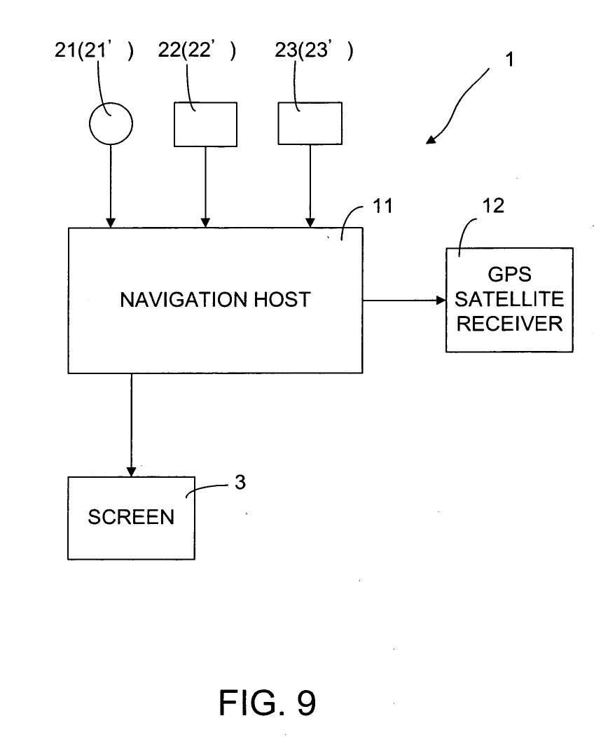

Referring to FIGS. 1 and 9, the single-handed operating navigation apparatus of the invention includes a base 1, a screen 3, a rotary disk 21, at least one selection item confirmation button 22 and at least one selection item activation button 23.

The base 11 contains a navigation host 11 and a GPS satellite receiver 12.

The screen 3 aims to display navigation information.

The rotary disk 21 is divided into a plurality of segments and can rotate clockwise or counterclockwise to provide rapid scan and selection. The rotary disk is preferably formed in circular.

The selection item confirmation button 22 aims to confirm a selection item.

The selection item activation button 23 aims to activate a selection item to be browsed by users.

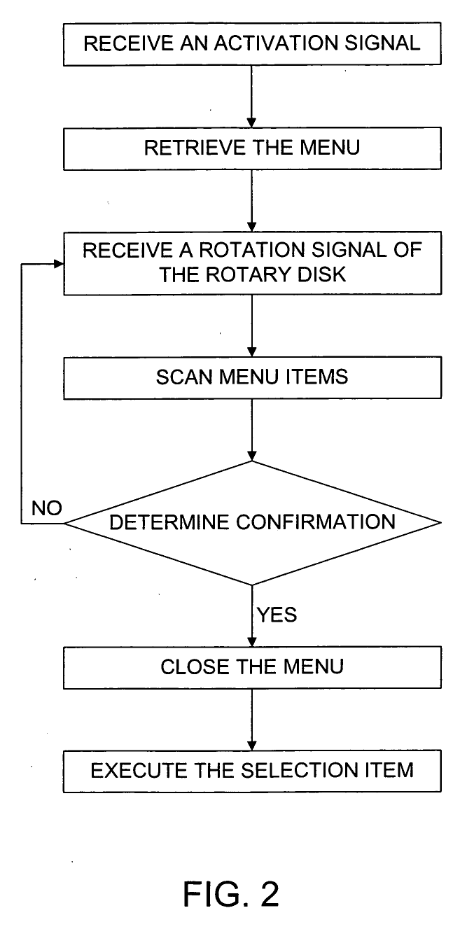

Refer to FIGS. 1, 2 and 9 for the operation flow of the invention as discussed below that is based on the construction set forth above.
Step 1—Receive an activation signal: The selection item activation button 23 is depressed by a user's finger to trigger the navigation host 11 to open a menu 30 on the screen 3;
Step 2—Retrieve the menu: The navigation host 11 opens the menu 30 according to the existing condition, and displays the menu 30 on the screen 3;
Step 3—Receive a rotation signal of the rotary disk: The rotary disk 21 generates a corresponding rotation signal according to the clockwise or counterclockwise angular displacement made by the finger based on the first touched position of the user on the rotary disk 21 that serves as the starting number;
Step 4—Scan menu items: Switch to and move a selection item lighting bar 32 according to the rotation signal;
   Step 5—Determine confirmation: Detect whether the user has depressed the selection item confirmation button 22; if positive, execute step 6; otherwise, return to step 3;
Step 6—Close the menu: Close the menu 30 on the existing screen 3.
Step 7—Execute the selection item: Execute menu instructions confirmed by the user.

The rotary disk 21 of the invention further has four polar buttons 211, 214, 213 and 212 for up, down, left and right sides to enable users to make fast selection.

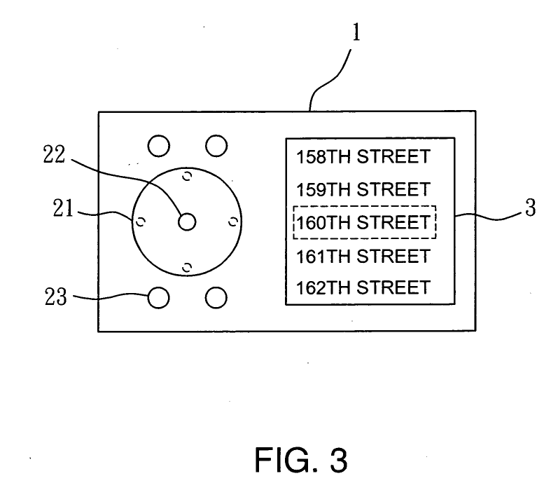

The screen 3 of the invention has upward and downward switch functions to allow the rotary disk 21 to be positioned on the left side (as shown in FIG. 3) or right side (as shown in FIG. 1) of the screen 3 to be used by the left hand or right hand of users.

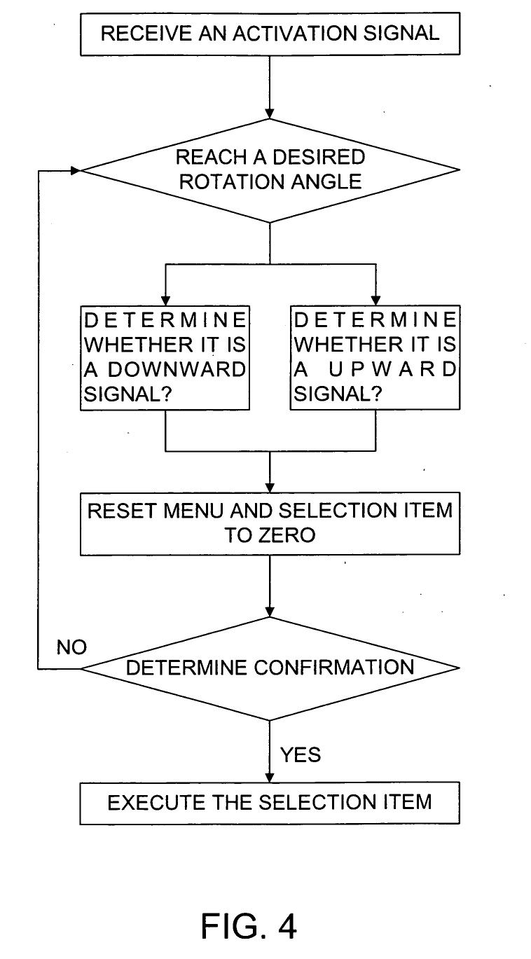

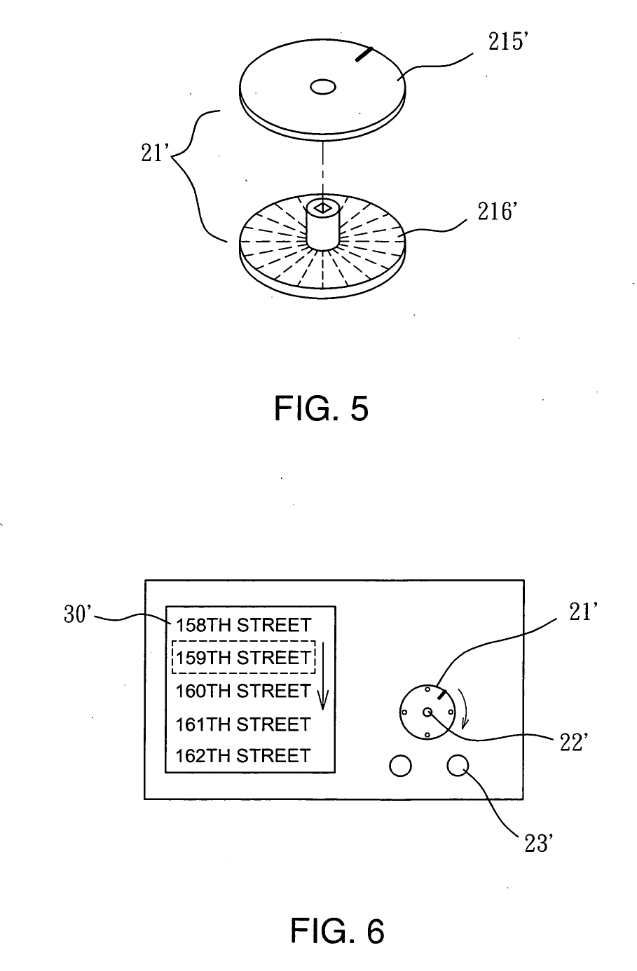

Refer to FIGS. 5 and 6 for a second embodiment of the invention. The rotary disk 21′ is a mechanical one and mainly includes a disk dock 216′ and a rotary wheel 215′ coupling thereon. When the rotary wheel 215′ rotates clockwise or counterclockwise for one segment, a displacement signal of adding or subtracting one is output. Thereby it is transformed to the movement of the selection items on the menu on the screen. The process flow is as follow (referring to FIGS. 4 and 6):
Step 1—Receive an activation signal: User touches and moves the rotary disk 21′ and the selection item activation button 23′ to trigger the navigation host 11 to open a menu 30′;
Step 2—Reach a desired rotation angle: Determine and detect the rotational direction of the rotary disk 21′, and execute step 3 for clockwise direction, or execute step 4 for counterclockwise direction;
Step 3—Downward signal: Move a segment signal of a selection item of the menu downwards for one unit when the rotary disk 21′ is rotated clockwise for one segment to make the selected item of the menu 30′ on the screen 3 to be moved downwards correspondingly, and execute step 5;
Step 4—Upward signal: Move a segment signal of a selection item of the menu upwards for one unit when the rotary disk 21′ is rotated counterclockwise for one segment to make the selection item of the menu 30′ on the screen 3 to be moved upwards correspondingly, and execute step 5;
Step 5—Reset the menu and selection item to zero: Determine whether the selection item of the menu is the last one or first one, if positive, move the selection item of the menu 30′ to the first item or the last item;
Step 6—Determine confirmation: Detect whether the selection item confirmation button 22′ is depressed; if positive, execute step 7; otherwise, return to step 2;
Step 7—Execute the selection item: Execute menu instructions confirmed by the user.

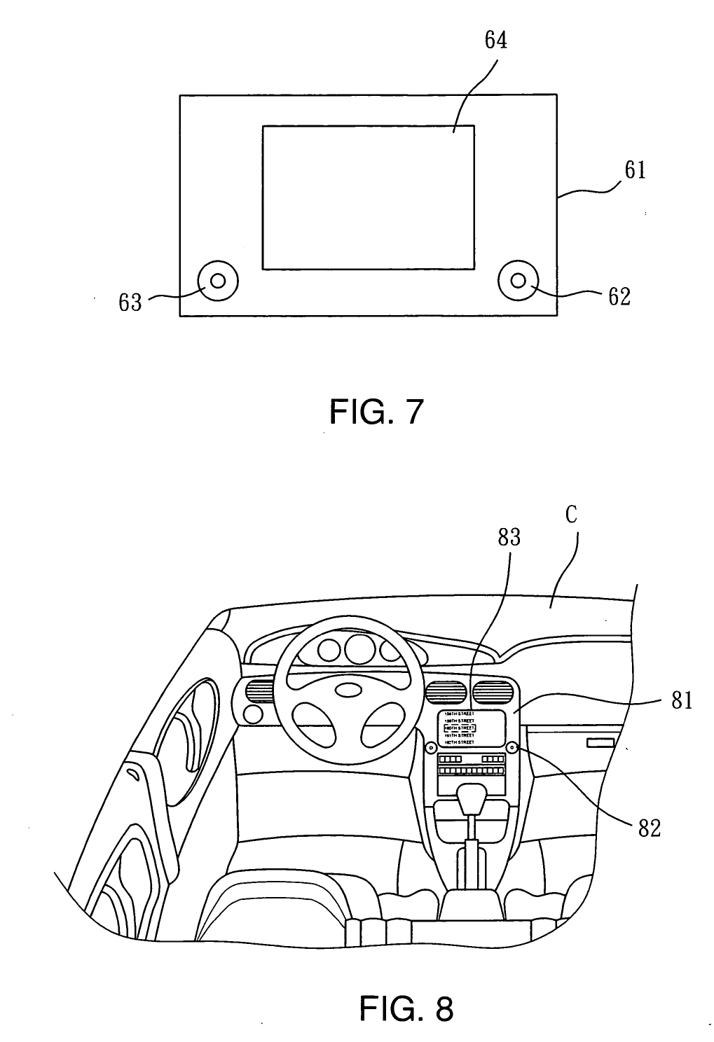

Referring to FIG. 7 for a third embodiment of the invention. To facilitate left hand or right hand operation, the base 61 has a right rotary disk 62 and a left rotary disk 63 on two sides of the screen 64 close to the positions where the right hand and left hand are grasping. Thereby it can be operated easily by users right-handed or left-handed.

Thus the navigation apparatus of the invention set forth above can be operated single-handed. Beside to provide a hand-held operation, it also can be installed on a dashboard 81 of a vehicle C as shown in FIG. 8. And one or more rotary disk 82 is installed close to the screen 83 to enable a driver to rapidly do navigation setting single-handed.

I claim:

1. A single-handed operating navigation apparatus comprising a base, a screen, a rotary disk, at least one selection item confirmation button, and at least one selection item activation button; wherein:
the base contains a navigation host and a GPS satellite receiver;
the rotary disk has a plurality of divided segments corresponding to selection items on the screen and is turnable clockwise or counterclockwise to provide rapid scanning and operation of the selection items;
the screen displays navigation information;
the selection item confirmation button provides confirmation of the selection items; and
the selection item activation button activates the selection items to be browsed by users.

2. The single-handed operating navigation apparatus of claim 1, wherein the rotary disk is turnable continuously clockwise or counterclockwise.

3. The single-handed operating navigation apparatus of claim 1, wherein the rotary disk is a capacitance touch sensitive plate having one dimensional coordinates that has a head and a tail connecting to each other.

4. The single-handed operating navigation apparatus of claim 1, wherein the rotary disk is a capacitance touch sensitive plate having two dimensional coordinates that has a head and a tail connecting to each other.

5. The single-handed operating navigation apparatus of claim 1, wherein the rotary disk is a mechanical rotary wheel.

6. The single-handed operating navigation apparatus of claim 1, wherein the rotary disk has four polar buttons for up, down, left and right sides to function as directional buttons for up, down, left and right directions.

7. The single-handed operating navigation apparatus of claim 1, wherein the screen has upward and downward switch functions.

8. The single-handed operating navigation apparatus of claim 1, wherein at least one of the selection item confirmation button and the selection item activation item is located beneath the rotary disk.

9. The single-handed operating navigation apparatus of claim 1, wherein rotary disk is circular.
